(19) United States
(12) Patent Application Publication
(10) Pub. No.: US 2026/0342964 A1
(43) Pub. Date: Oct. 29, 2026

(54) REFERENCE LIST REORDERING IN VIDEO CODING

(71) Applicant: MEDIATEK INC., Hsinchu City (TW)

(72) Inventors: Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW)

(21) Appl. No.: 18/997,298

(22) PCT Filed: Jun. 30, 2023
(86) PCT No.: PCT/CN2023/104342

§ 371 Date: Jan. 21, 2025

Related U.S. Application Data
(60) Provisional application No. 63/369,089, filed on Jul. 22, 2022.
(60) Provisional application No. 63/491,557, filed on Mar. 22, 2023.

(51) Int. Cl. H04N 19/105; H04N 19/172; H04N 19/176; H04N 19/52; H04N 19/70; H04N 19/96

(52) U.S. Cl. CPC H04N 19/105; H04N 19/172; H04N 19/176; H04N 19/52; H04N 19/70; H04N 19/96

(57) ABSTRACT

A method for coding video pictures by reordering a reference picture list (RPL) is provided. A video coder receives a RPL for a current coding tree unit (CTU) of a current picture. The RPL identifies a plurality of reference pictures. The video coder assigns indices to the plurality of reference pictures in the RPL of the current CTU. The video coder receives data to be encoded or decoded as a plurality of blocks of the current CTU. The video coder encodes or decodes the plurality of blocks of the CTU by using the assigned indices to select one or more reference pictures from the RPL to generate inter-predictions.

### CROSS REFERENCE TO RELATED PATENT APPLICATION(S)

The present disclosure is part of a non-provisional application that claims the priority benefit of U.S. Provisional Patent Application No. 63/369,089 filed on 22 Jul. 2022 and U.S. Provisional Patent Application No. 63/491,557, and 22 Mar. 2023, respectively. Contents of above-listed applications are herein incorporated by reference.

### TECHNICAL FIELD

The present disclosure relates generally to video coding. In particular, the present disclosure relates to methods of coding pixel blocks by inter-prediction using reference lists.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for coding video pictures by reordering a reference picture list (RPL). A video coder receives a RPL for a current coding tree unit (CTU) of a current picture. The RPL identifies a plurality of reference pictures. The video coder assigns indices to the plurality of reference pictures in the RPL of the current CTU. The video coder receives data to be encoded or decoded as a plurality of blocks of the current CTU. The video coder encodes or decodes the plurality of blocks of the CTU by using the assigned indices to select one or more reference pictures from the RPL to generate inter-predictions.

In some embodiments, the indices are assigned to the plurality of reference pictures in the RPL based on explicit signaling. In some embodiments, the indices are assigned to the plurality of reference pictures in the RPL based on a history-based table that records the distribution of reference picture selections when encoding or decoding each CTU of the current picture.

In some embodiments, the video coder derives a representative MV of the current CTU and computes costs for the plurality of reference pictures. The cost of each reference picture is computed based on (i) neighboring samples of the current CTU and (ii) reference samples in the reference picture identified by the representative MV, and the indices are assigned to the plurality of reference pictures in the RPL based on the computed costs.

In some embodiments, the representative MV is derived from MVs used to reconstruct one or more blocks neighboring the current CTU, and the representative MV may be a weighted average of the MVs used to reconstruct the blocks neighboring the current CTU. In some embodiments, the representative MV is derived from MVs from one or more blocks in the current CTU, and the representative MV may be a weighted average of the MVs from the one or more blocks in the current CTU. In some embodiments, the representative MV is derived from temporal MVs from a collocated CTU or a reference picture CTU, and the representative MV may be a weighted average of the temporal MVs from the collocated CTU or the reference picture CTU. The representative MV is derived from MVs inherited from neighboring locations of the current CTU. The video coder may use a motion vector predictor (MVP) of a block in the current CTU as the representative MV of the CTU.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1A-B show various syntax structures and elements related to reference picture management signaling.

FIG. 2 conceptually illustrates reconstruction samples used in coding tree unit (CTU) based reference picture list reordering.

FIG. 3 conceptually illustrates using a representative motion vector (MV) of a CTU to reorder a reference picture list (RPL) of the CTU.

FIG. 4 illustrates neighboring location used in CTU-based reference list reordering.

FIG. 5 illustrates the current CTU and the previously coded CTUs in the current picture.

FIG. 6 illustrates an example video encoder that may implement CTU-based reference picture list.

FIG. 7 illustrates portions of the video encoder that implement CTU-based reference picture list.

FIG. 8 conceptually illustrates a process for using CTU-based reference picture list to encode blocks of pixels.

FIG. 9 illustrates an example video decoder that may implement CTU-based reference picture list.

FIG. 10 illustrates portions of the video decoder that implement CTU-based reference picture list.

FIG. 11 conceptually illustrates a process for using CTU-based reference picture list to decode blocks of pixels.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Reference Picture Management

A video coding system performs reference picture management for inter prediction with multiple reference pictures. Reference picture management manages the storage and removal of reference pictures into and from the decoded picture buffer (DPB) and puts the reference pictures in a proper order in a reference picture list (RPL). When a picture is referenced for inter-picture prediction (either as a temporal reference or an inter-layer reference), an index into an RPL is used to select which picture in the DPB is being referenced. The reference picture management may use a DPB and up to two RPLs. The reference picture management may also mark reference pictures as “used for short-term reference”, “used for long-term reference”, and “unused for reference”.

Picture order count (POC) is a variable that is derived as an output order indicator and is used as an identifier of pictures in the coding process, including DPB management and reference picture management. To minimize signaling overhead bit costs while maintaining robustness against data losses, the most significant bits (MSBs) of the POC value may not be sent in the bitstream, because frequently only the differences between POC values are necessary for proper operation of the coding process.

The POC's least significant bits (LSBs), which are used for deriving the POC value and have the same value for all slices of a picture, are signaled in the picture header (PH), or slice header (SH). The POC MSB cycle value may be signaled in the PH to enable the derivation of the POC value without tracking POC MSBs in a way that relies on the POC information of earlier coded pictures. This, for example, allows the mixing of intra random access pictures (IRAP) and non-IRAP pictures within an access unit (AU) in multi-layer bitstreams. POC LSB information may be signaled for every picture, including instantaneous decoder refresh (IDR) pictures. The POC LSBs may not be signaled for IDR pictures, which saves a few bits for the IDR pictures. The signaling of POC LSB information for IDR pictures also facilitates the merging of IDR pictures and non-IDR pictures from different bitstreams into a single coded picture.

In some embodiments, for all types of slices (e.g., B, P, and I slices), two RPLs, called list 0 (L0 or RPL 0) and list 1 (L1 or RPL 1) are directly signaled and derived, without using an RPL initialization or modification process. In some embodiments, the RPLs are not based on reference picture sets or sliding window plus memory management control operation processes.

Reference picture marking is directly based on RPLs 0 and 1, indicating both active and inactive entries in the RPLs, where only the active entries may be used by reference indices in inter prediction of the current picture.

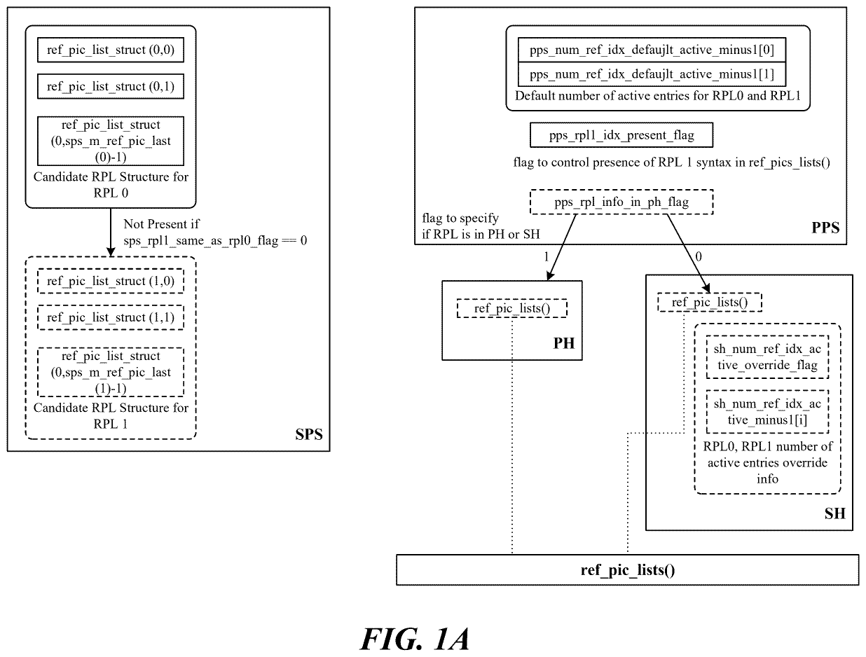

FIGS. 1A-B show various syntax structures and elements related to reference picture management signaling that are included in the sequence parameter set (SPS), picture parameter set (PPS), PH, and SH. In the figure, the syntax elements that are always present are shown in solid rectangles and those that are conditionally present are shown in dotted rectangles. A number of predefined candidate RPL syntax structures (e.g., the ref_pic_list_struct (listIdx, rplsIdx) syntax structures) may be signaled in the SPS, for RPL 0 and for RPL 1 (if different from those for RPL 0), for use by referencing them in the PH or SH.

The syntax elements in the PPS indicate the default number of active entries for RPL 0 and RPL 1, a flag to control the presence of RPL 1 syntax in the ref_pic_lists( ) structure, and a flag that specifies whether the RPL information is included in the PH or SH. Information for the derivation of the two RPLs (i.e. the ref_pic_lists( ) structures) is signaled either in the PH, if all slices of the picture have the same RPLs, or in the SH. Instead of referencing a predefined candidate RPL structure (identified via rpl_idx[i]), another RPL structure (i.e. a ref_pic_list_struct(i, sps_num_ref_pic_lists[i]) structure) can also be directly signaled in the PH and SH.

Each RPL syntax structure includes information for a number of reference picture entries for the particular RPL. A reference picture entry in the RPL is either a short-term reference picture entry, a long-term reference picture entry, or an inter-layer reference picture entry. The default numbers of active entries for RPL 0 and RPL 1 are signaled in the PPS (i.e. pps_num_ref_idx_default_ active_minus1[i]) and can be overridden (using the syntax elements sh_num_ref_idx_active_override_flag and sh_num_ref_idx_active_minus1[i]) in the SH.

### II. Reference List Reordering

In some embodiments, a reference picture reordering method is used to allow block level adaptation of reference picture index assignment. The reference picture reordering may be based on template matching cost. For uni-prediction AMVP mode, the reference pictures in List 0 and List 1 are interweaved to generate a joint list. For each hypothesis of the reference picture in the joint list, motion information can be derived accordingly, and template matching is performed to calculate the cost. The joint list is reordered based on ascending order of the template matching cost. The index of the selected reference picture in the reordered joint list is signaled in the bitstream. For the bi-prediction AMVP mode, a list of pairs of reference pictures from List 0 and List 1 is generated and similarly reordered based on the template matching cost. The index of the selected pair is signaled in the bitstream.

In some embodiments, the result of extending the number of active reference pictures in the random-access configuration by setting the number of active reference pictures is equal to the number of available reference pictures reported. In some embodiments, a block level reference picture reordering method based on template matching may be used. For uni-prediction AMVP mode, the reference pictures in List 0 and List 1 are interweaved to generate a joint list. For each hypothesis of the reference picture in the joint list, template matching is performed to calculate the cost. The joint list is reordered based on ascending order of the template matching cost. The index of the selected reference picture in the reordered joint list is signaled in the bitstream. For the bi-prediction AMVP mode, a list of pairs of reference pictures from List 0 and List 1 is generated and similarly reordered based on the template matching cost. The index of the selected pair is signaled in the bitstream.

In some embodiments, sign prediction for motion vector difference (MVD) is applied to the regular and affine AMVP modes. The derivation of the predicted MVD signs requires the reference pictures to be known. However, the reference picture reordering method requires the MVDs to be known in the process. To solve this problem, the minimum template matching cost among all MVD sign hypothesis is assigned to the reference picture hypothesis. Then, the selected reference picture can be determined by the decoded index and the reordered reference picture list. The MVD sign prediction is performed thereafter by reusing the calculated template matching cost. For simplification, in the case of bi-prediction, MVD sign prediction in List 1 is only enabled if MVD in list 0 is zero.

### III. CTU-based Reference List Reordering

Some embodiments of the disclosure provide a CTU-based reference picture list (RPL) reordering method. Specifically, when coding a CTU, before encoding or decoding the first block or the first AMVP or the first inter block of the CTU, the reference picture list is reordered implicitly or explicitly (by signaling). All blocks in the CTU use the same reordered reference pictures. All blocks in the CTU use the same reference picture order. The CTU-based ordering of reference pictures can be determined according to template matching costs or SAD costs between reconstructed samples neighboring the current CTU and their corresponding reference samples (or predictor samples) in the reference pictures.

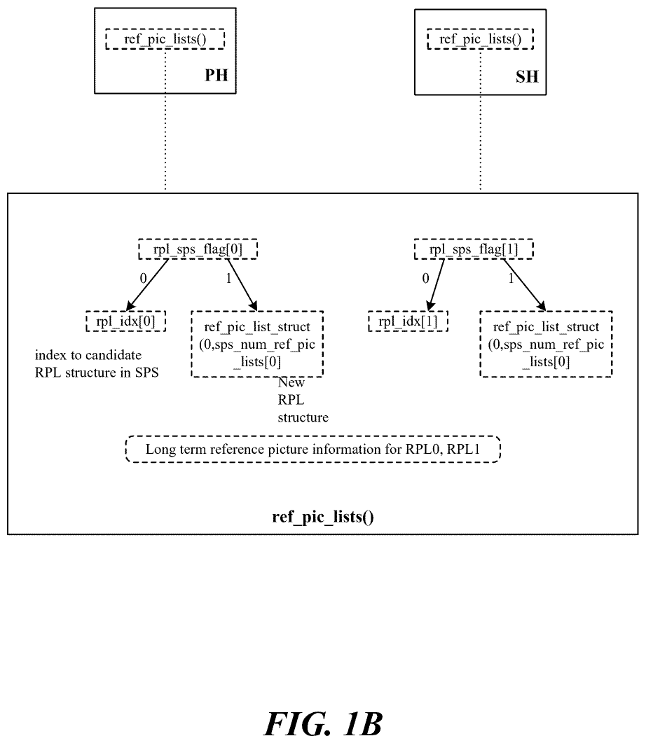

In the CTU-based reference list reordering method, reconstruction samples neighboring the current CTU may be used to perform reference picture reordering. FIG. 2 conceptually illustrates reconstruction samples used in CTU-based reference picture list reordering. In the figure, samples in the shaded region neighboring the current CTU 200 may be used for CTU-based reference picture list reordering for the current CTU 200. These neighboring reconstruction samples may be samples of the blocks neighboring the current CTU 200. These neighboring blocks of the CTU 200 may be blocks of the CTU A, CTU B, and CTU D, which are CTUs neighboring the current CTU 200.

The CTU 200 is associated with a CTU-based RPL 240, which includes reference pictures A, B, C, and D. In some embodiments, the costs used for ordering a RPL are the computed differences between the reconstructed samples neighboring the current CTU and their corresponding reference samples in the different reference pictures of the RPL. These reference samples are in reference blocks identified by a motion source of the current CTU, which can be a representative MV 220 of the current CTU 200. The representative MV 220 of the current CTU 220 can be derived or determined from neighboring reconstruction blocks in neighboring CTUs, one or more inter-predicted blocks in current CTU, one or more AMVP mode blocks in current CTU, temporal MVs in collocated picture or reference pictures, history-based MVs or history-based motion info. The cost metrics used to determine the order of reference picture can be template matching cost, SAD cost or SATD cost, or SSE cost, or other difference measures between reconstructed samples neighboring the current CTU and corresponding reference samples in different reference pictures referenced/identified by the representative MV.

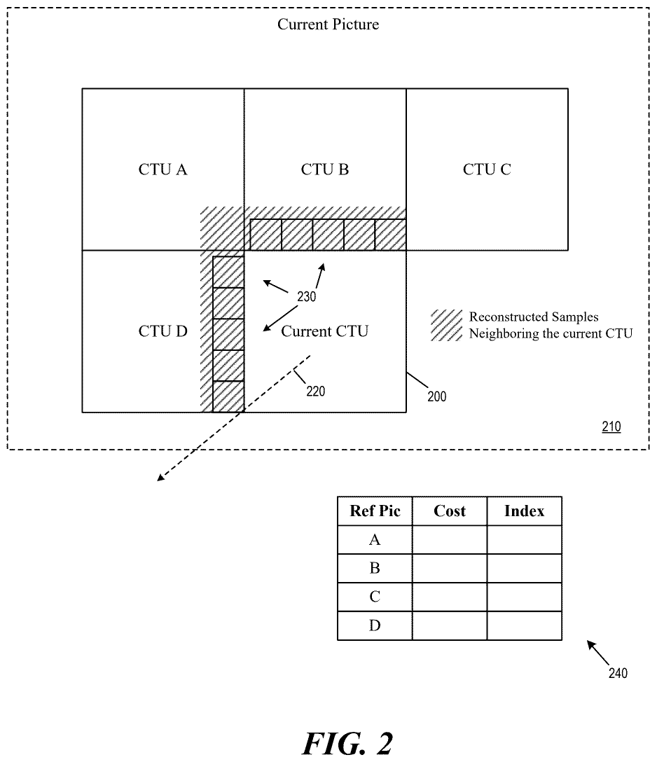

FIG. 3 conceptually illustrates using a representative MV of a CTU to reorder the reference picture list (RPL) of the CTU. For the CTU 200, the RPL 240 identifies four reference pictures 301-304 (Ref Pic A-D). The representative MV 220 is used to locate reference blocks or samples in these reference pictures 301-304, and these reference blocks or samples are in turn used for computing the costs of these reference pictures.

As illustrated, the current CTU 200 is in the current picture 210. Neighboring samples or neighboring blocks 230 of the current CTU 200 are to be used for computing TM costs. The representative MV 220 of the CTU 200 is derived for reordering the RPL 240. The representative MV 220 is used to identify reference blocks or reference samples 331-334 in the different reference pictures 301-304. The reference blocks or reference samples 331-334 provide the reference samples that correspond to the neighboring samples 230 of the current CTU 200.

The cost associated with the reference picture 301 (Ref Pic A) is computed as the difference between the reference blocks/samples 331 and the neighboring samples/blocks 230. The cost associated with the reference picture 302 (Ref Pic B) is computed as the difference between the reference blocks/samples 332 and the Neighboring samples/blocks 230. The cost associated with the reference picture 303 (Ref Pic C) is computed as the difference between the reference blocks/samples 333 and the Neighboring samples/blocks 230. The cost associated with the reference picture 304 (Ref Pic D) is computed as the difference between the reference blocks/samples 334 and the Neighboring samples/blocks 230.

In the example, the cost computed for Ref Pic B (the reference picture 302) is the lowest among all reference pictures in the RPL 240, it is therefore assigned reordered index 0. The cost computed for Ref Pic C (the reference picture 303) is the second lowest, it is therefore assigned reordered index 1. Ref Pic D has the third lowest cost in the RPL and assigned index 2. Ref Pic A has the fourth lowest cost in the RPL and assigned index 3, etc.

In some embodiments, MVs or motion information from one or more neighboring reconstruction blocks in a CTU neighboring the current CTU is used as the representative MV of the current CTU. In some embodiment, MVs or motion from the last N neighboring reconstructed blocks (N≥0) in neighboring CTU(s) are used as the representative MV of the current CTU. In some embodiments, MVs or motion from the one or more neighboring reconstructed blocks in neighboring CTU(s) are weighted or averaged and the weighted MV or the averaged MV is used as the representative MV of the current CTU.

In some embodiment, MVs or motion from the one or more blocks in the current CTU is used as the representative MV of the current CTU. In some embodiments, MVs or motion from the one or more inter-predicted blocks or one or more AMVP mode blocks in current CTU is used as the representative MV of the current CTU.

In some embodiments, MVs or motion from the first N blocks (N≥0) in the current CTU is used as the representative MV of the current CTU. In some embodiments, MVs or motion from the one or more blocks in the current CTU are weighted or averaged and the weighted MV or the averaged MV is used as representative MV of the current CTU.

In some embodiments, temporal MVs from a collocated CTU or temporal MVs from a reference picture CTU is used as the representative MV of the current CTU. In some embodiments, temporal MVs from a collocated CTU or temporal MVs from a reference picture CTU are weighted or averaged and the weighted MV or the averaged MV is used as the representative MV of the current CTU.

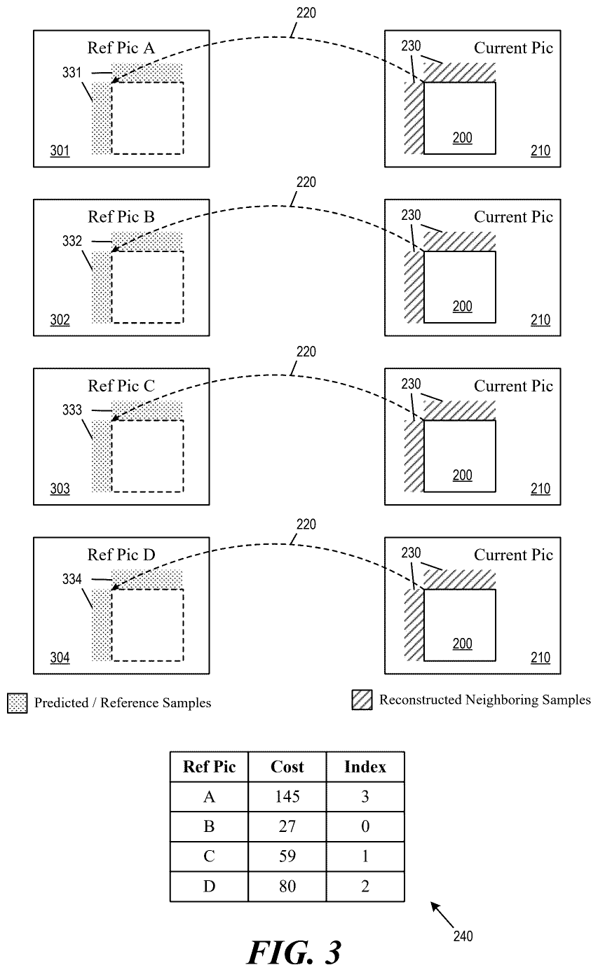

In some embodiments, (one of the) MVs from neighboring locations of the current CTU are inherited as the representative MV of the current CTU. FIG. 4 illustrates neighboring location used in CTU-based reference list reordering. The figure illustrates a current CTU 400. The neighboring locations (e.g., A0, A1, A2, B0, B1, C0, C1 in the figure) can be neighboring CTUs or neighboring reconstruction blocks, and the neighboring reconstruction samples of the current CTU is used to determine the reference picture order.

In some embodiments, history-based motion information or history-based MVs is used as the representative MV of the current CTU.

In some embodiments, the process of reference picture reordering is signaled per frame or picture, instead of per CTU. Before encoding or decoding the current picture, the reference picture list can be reordered according to explicit signaling or flags. The order of the reference pictures can also be determined implicitly for each frame or picture.

In some embodiments, before encoding or decoding, a joint list (of reference pictures) for uni-prediction and a joint list (of reference pictures) for bi-prediction are formed and the reordering process is performed afterwards. No additional redundancy check process in formation of joint list is performed, and thus more reference pictures can be inserted into the joint list.

In some embodiments, when motion vector difference (MVD) sign derivation is enabled, reordering is performed before the MVD sign derivation. Since the sign of MVD is not yet decided, to determine the order of reference picture list, the motion vector predictor (MVP) is used (as the representative MV of the CTU) to firstly determine the template matching costs or SATD costs between neighboring reconstructed blocks and the corresponding reference blocks in the reference pictures in the RPL.

In some embodiments, all MVPs from different reference pictures are scaled to the current reference picture when calculating difference/costs between the current picture and the current reference picture.

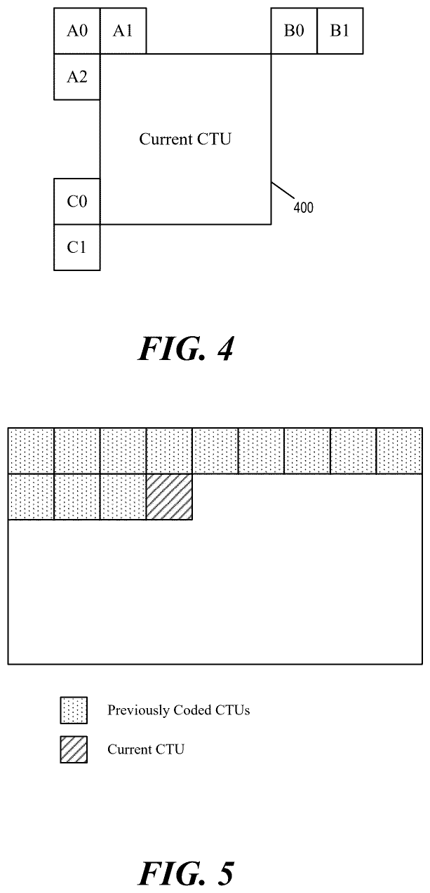

In some embodiments, when encoding or decoding current CTU, the order of reference pictures is determined based on the reference picture distribution of the previous coded CTUs. (FIG. 5 illustrates the current CTU and the previously coded CTUs in the current picture.) For example, the order of reference pictures in the current CTU depends on the reference picture distribution of one previously coded CTU. For another example, the order of refence pictures in the current CTU depends on the reference picture distribution of the previously coded CTU row. For another example, a history-based table records the distribution of reference picture selections when encoding or decoding each CTU, and the history-based table is used for reference picture ordering of the current CTU.

Any of the foregoing proposed methods can be implemented in encoders and/or decoders. For example, any of the proposed methods can be implemented in predictor derivation module of an encoder, and/or a predictor derivation module of a decoder. Alternatively, any of the proposed methods can be implemented as a circuit coupled to the predictor derivation module of the encoder and/or the predictor derivation module of the decoder, so as to provide the information needed by the predictor derivation module.

### IV. Example Video Encoder

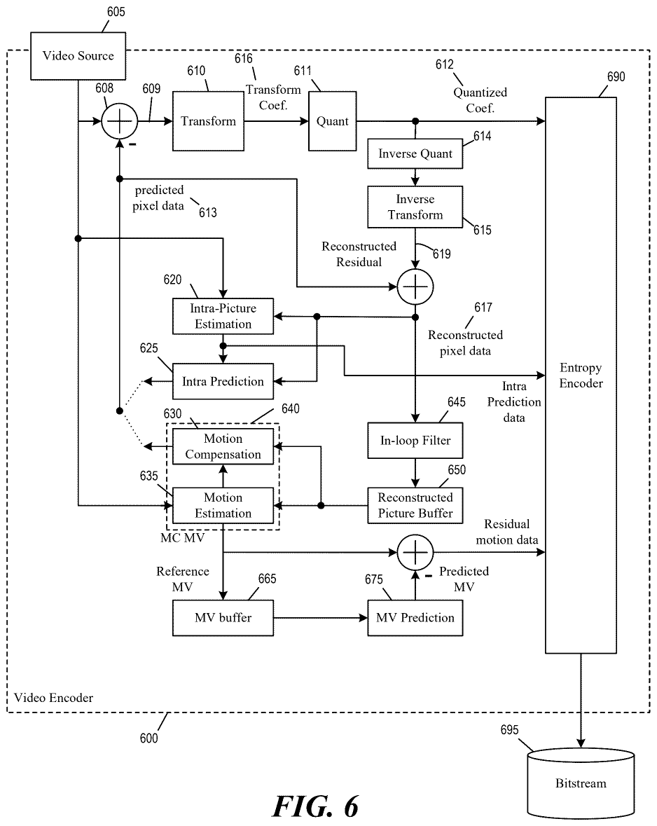

FIG. 6 illustrates an example video encoder 600 that may implement CTU-based reference picture list. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

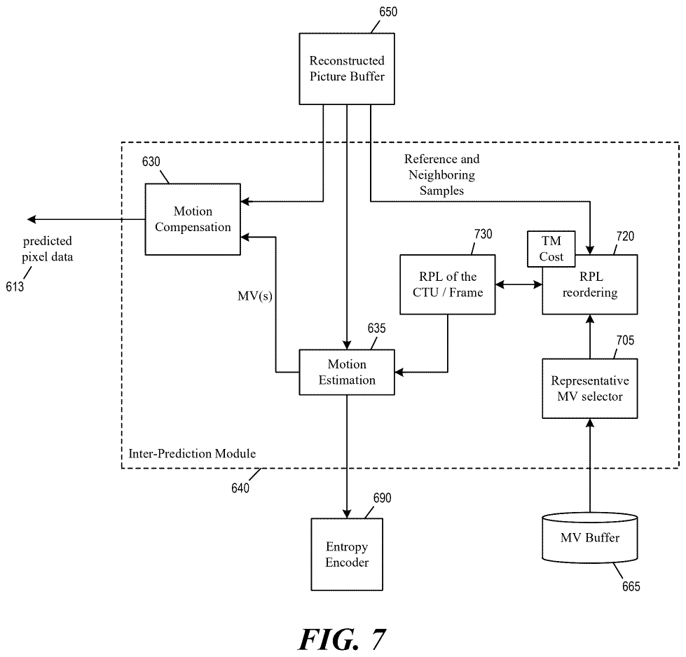

FIG. 7 illustrates portions of the video encoder 600 that implement CTU-or frame-based reference picture list. Specifically, the figure illustrates the components of the inter-prediction module 640 of the video encoder 600. As illustrated, the inter-prediction module 640 retrieves candidate motion vectors from the MV buffer 665 and searches the content of the reconstructed picture buffer 650 to generate the predicted pixel data 613 by motion compensation.

The inter-prediction module 640 includes the motion compensation module 630, the motion estimation module 635, a representative MV selector 705, a reference picture list reordering module 710, and a reference picture list (RPL) 730 of the current CTU or frame.

The representative MV selector 705 retrieves candidate motion vectors from the MV buffer 665 to derive or select a representative MV of the current CTU or frame. The representative MV selector 705 may derive or select the representative MV from MVs used to reconstruct one or more blocks neighboring the current CTU, or MVs from one or more blocks in the current CTU, or temporal MVs from a collocated CTU or a reference picture CTU, or MVs inherited from neighboring locations of the current CTU, or a motion vector predictor (MVP) of a block in the current CTU.

The RPL reordering module 720 uses the selected or derived representative MV (from 705) to calculate the template matching (TM) costs associated with the reference pictures in the RPL 730. In some embodiments, the cost associated with each reference picture in the RPL 730 is determined based on a difference measure between (i) neighboring samples or neighboring blocks of the current CTU and (ii) corresponding reference samples in the reference picture that are identified by the representative MV. (The neighboring samples and reference samples are retrieved from the reconstructed picture buffer 650.) Based on the calculated costs, the RPL reordering module 720 assigns indices to the reference pictures in the RPL 730.

The motion estimation module 635 performs motion estimation to provide one or more motion vectors to the motion compensation module 630 to perform motion compensation. The motion estimation module 635 also signals the selected motion vector(s) to the entropy encoder by using the indices assigned to the reference pictures in the RPL 730.

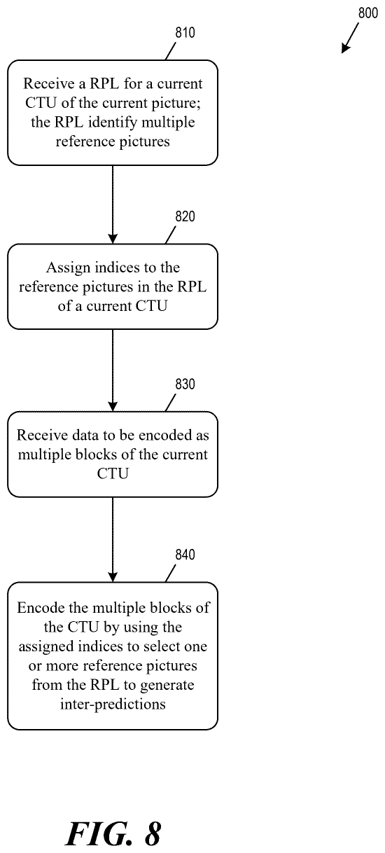

FIG. 8 conceptually illustrates a process 800 for using CTU-based reference picture list to encode blocks of pixels. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The video encoder receives (at block 810) a reference picture list (RPL) of a current coding tree unit (CTU) of the current picture. The RPL identifies a plurality of reference pictures.

The video encoder assigns (at block 820) indices to the plurality of reference pictures in the RPL of the current CTU. In some embodiments, the indices are assigned to the plurality of reference pictures in the RPL based on explicit signaling. In some embodiments, the indices are assigned to the plurality of reference pictures in the RPL based on a history-based table that records the distribution of reference picture selections when encoding or decoding each CTU of the current picture.

In some embodiments, the video encoder derives a representative motion vector (MV) of the current CTU and computes costs for the plurality of reference pictures. The cost of each reference picture is computed based on (i) neighboring samples of the current CTU and (ii) reference samples in the reference picture identified by the representative MV, and the indices are assigned to the plurality of reference pictures in the RPL based on the computed costs.

In some embodiments, the representative MV is derived from MVs used to reconstruct one or more blocks neighboring the current CTU, and the representative MV may be a weighted average of the MVs used to reconstruct the blocks neighboring the current CTU. In some embodiments, the representative MV is derived from MVs from one or more blocks in the current CTU, and the representative MV may be a weighted average of the MVs from the one or more blocks in the current CTU. In some embodiments, the representative MV is derived from temporal MVs from a collocated CTU or a reference picture CTU, and the representative MV may be a weighted average of the temporal MVs from the collocated CTU or the reference picture CTU. The representative MV is derived from MVs inherited from neighboring locations of the current CTU. The video encoder may use a motion vector predictor (MVP) of a block in the current CTU as the representative MV of the CTU.

The video encoder receives (at block 830) data to be encoded as a plurality of blocks of the current CTU. The video encoder encodes (at block 840) the plurality of blocks of the CTU by using the assigned indices to select one or more reference pictures from the RPL to generate inter-predictions for the plurality of blocks of the current CTU.

### V. Example Video Decoder

In some embodiments, an encoder may signal (or generate) one or more syntax element in a bitstream, such that a decoder may parse said one or more syntax element from the bitstream.

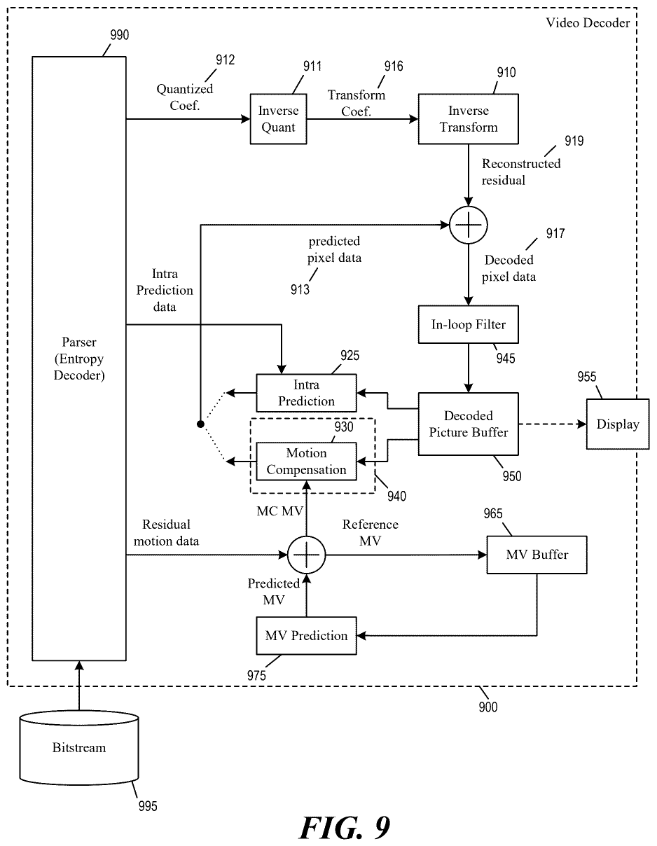

FIG. 9 illustrates an example video decoder 900 that may implement CTU-or frame-based reference picture list. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

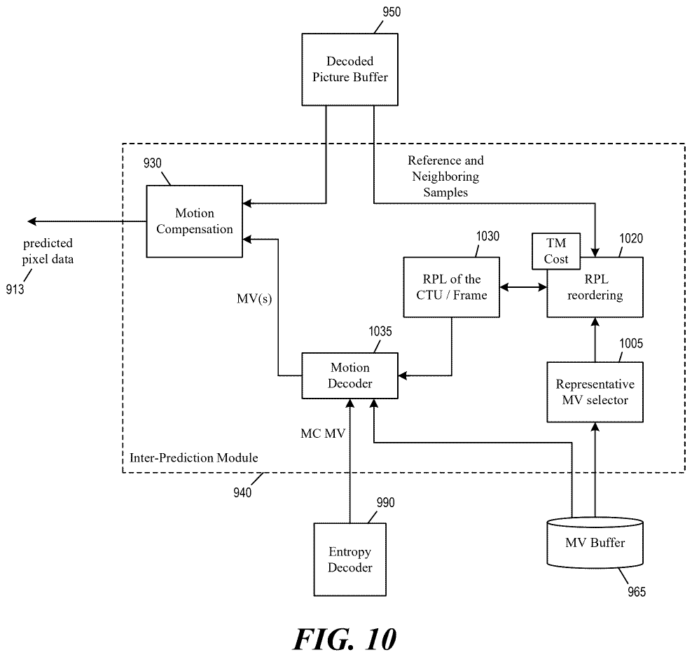

FIG. 10 illustrates portions of the video decoder 900 that implement CTU- or frame-based reference picture list. Specifically, the figure illustrates the components of the inter-prediction module 940 of the video decoder 900. As illustrated, the inter-prediction module 940 retrieves candidate motion vectors from the MV buffer 965 and the content of the decoded picture buffer 950 to generate the predicted pixel data 913 by motion compensation.

The inter-prediction module 940 includes the motion compensation module 930, the motion decoder 1035, a representative MV selector 1005, a reference picture list reordering module 1010, and a reference picture list (RPL) 1030 of the current CTU or frame.

The representative MV selector 1005 retrieves candidate motion vectors from the MV buffer 965 to derive or select a representative MV of the current CTU or frame. The representative MV selector 1005 may derive or select the representative MV from MVs used to reconstruct one or more blocks neighboring the current CTU, or MVs from one or more blocks in the current CTU, or temporal MVs from a collocated CTU or a reference picture CTU, or MVs inherited from neighboring locations of the current CTU, or a motion vector predictor (MVP) of a block in the current CTU.

The RPL reordering module 1020 uses the selected or derived representative MV (from 1005) to calculate the template matching (TM) costs associated with the reference pictures in the RPL 1030. In some embodiments, the cost associated with each reference picture in the RPL 1030 is determined based on a difference measure between (i) neighboring samples or neighboring blocks of the current CTU and (ii) corresponding reference samples in the reference picture that are identified by the representative MV. (The neighboring samples and reference samples are retrieved from the decoded picture buffer 950.) Based on the calculated costs, the RPL reordering module 1020 assigns indices to the reference pictures in the RPL 1030.

The entropy decoder 990 receives signaling indicating the motion information of the current block and relays the motion information to the motion decoder 1035 as the MV for motion compensation (MC MV). The motion decoder 1035 may identify one or more reference picture(s) in the RPL 1030 using index or indices provided by the entropy decoder 990. The compensation module 930 performs motion compensation using prediction samples retrieved from the decoded picture buffer 950 according to the MC MV. The retrieved prediction samples are samples of the identified reference picture.

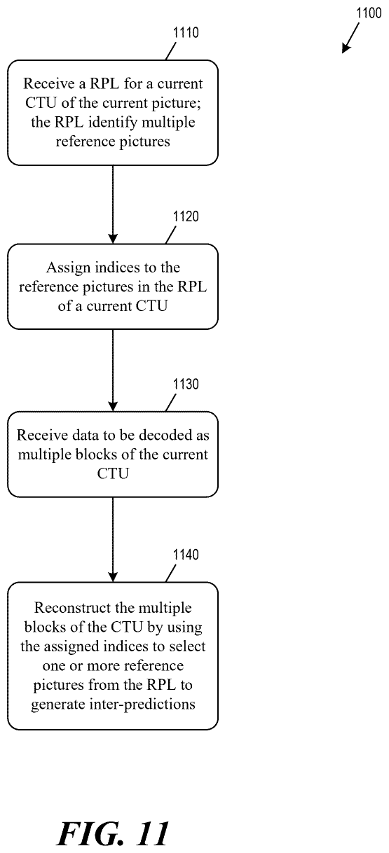

FIG. 11 conceptually illustrates a process 1100 for using CTU-based reference picture list to decode blocks of pixels. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The video decoder receives (at block 1110) a reference picture list (RPL) of a current coding tree unit (CTU) of the current picture. The RPL identifies a plurality of reference pictures.

The video decoder assigns (at block 1120) indices to the plurality of reference pictures in the RPL of the current CTU. In some embodiments, the indices are assigned to the plurality of reference pictures in the RPL based on explicit signaling. In some embodiments, the indices are assigned to the plurality of reference pictures in the RPL based on a history-based table that records the distribution of reference picture selections when decoding or decoding each CTU of the current picture.

In some embodiments, the video decoder derives a representative motion vector (MV) of the current CTU and computes costs for the plurality of reference pictures. The cost of each reference picture is computed based on (i) neighboring samples of the current CTU and (ii) reference samples in the reference picture identified by the representative MV, and the indices are assigned to the plurality of reference pictures in the RPL based on the computed costs.

In some embodiments, the representative MV is derived from MVs used to reconstruct one or more blocks neighboring the current CTU, and the representative MV may be a weighted average of the MVs used to reconstruct the blocks neighboring the current CTU. In some embodiments, the representative MV is derived from MVs from one or more blocks in the current CTU, and the representative MV may be a weighted average of the MVs from the one or more blocks in the current CTU. In some embodiments, the representative MV is derived from temporal MVs from a collocated CTU or a reference picture CTU, and the representative MV may be a weighted average of the temporal MVs from the collocated CTU or the reference picture CTU. The representative MV is derived from MVs inherited from neighboring locations of the current CTU. The video decoder may use a motion vector predictor (MVP) of a block in the current CTU as the representative MV of the CTU.

The video decoder receives (at block 1130) data to be decoded as a plurality of blocks of the current CTU. The video decoder reconstructs (at block 1140) the plurality of blocks of the CTU by using the assigned indices to select one or more reference pictures from the RPL to generate inter-predictions for the plurality of blocks of the current CTU. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

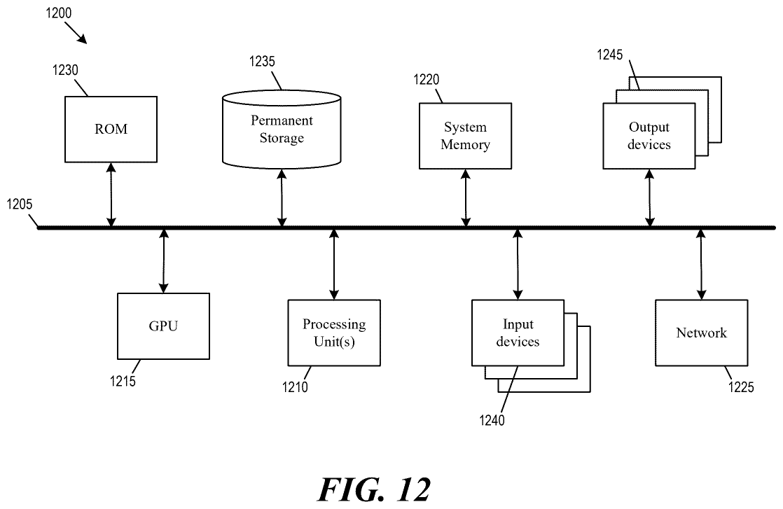

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving a reference picture list (RPL) for a current coding tree unit (CTU) of the current picture, the RPL identifying a plurality of reference pictures;
assigning indices to the plurality of reference pictures in the RPL of the current CTU;
receiving data to be encoded or decoded as a plurality of blocks of the current CTU; and
encoding or decoding the plurality of blocks of the CTU by using the assigned indices to select one or more reference pictures from the RPL to generate inter-predictions.

2. The video coding method of claim 1, wherein the indices are assigned to the plurality of reference pictures in the RPL based on explicit signaling.

3. The video coding method of claim 1, further comprising:
deriving a representative motion vector (MV) of the current CTU; and
computing costs for the plurality of reference pictures, wherein the cost of each reference picture is computed based on (i) neighboring samples of the current CTU and (ii) reference samples in the reference picture identified by the representative MV, wherein the indices are assigned to the plurality of reference pictures in the RPL based on the computed costs.

4. The video coding method of claim 3, wherein the representative MV is derived from MVs used to reconstruct one or more blocks neighboring the current CTU.

5. The video coding method of claim 4, wherein the representative MV is a weighted average of the MVs used to reconstruct the blocks neighboring the current CTU.

6. The video coding method of claim 3, wherein the representative MV is derived from MVs from one or more blocks in the current CTU.

7. The video coding method of claim 6, wherein the representative MV is a weighted average of the MVs from the one or more blocks in the current CTU.

8. The video coding method of claim 3, wherein the representative MV is derived from temporal MVs from a collocated CTU or a reference picture CTU.

9. The video coding method of claim 8, wherein the representative MV is a weighted average of the temporal MVs from the collocated CTU or the reference picture CTU.

10. The video coding method of claim 3, wherein the representative MV is derived from MVs inherited from neighboring locations of the current CTU.

11. The video coding method of claim 3, wherein a motion vector predictor (MVP) of a block in the current CTU is used as the representative MV of the CTU.

12. The video coding method of claim 3, wherein the neighboring samples of the current CTU are in CTUs neighboring the current CTU.

13. The video coding method of claim 1, the indices are assigned to the plurality of reference pictures in the RPL based on a history-based table that records the distribution of reference picture selections when encoding or decoding each CTU of the current picture.

14. An electronic apparatus comprising:
a video coder circuit configured to perform operations comprising:
receiving a reference picture list (RPL) for a current coding tree unit (CTU) of the current picture, the RPL identifying a plurality of reference pictures;
assigning indices to the plurality of reference pictures in the RPL of the current CTU;
receiving data to be encoded or decoded as a plurality of blocks of the current CTU; and
encoding or decoding the plurality of blocks of the CTU by using the assigned indices to select one or more reference pictures from the RPL to generate inter-predictions.

15. A video decoding method comprising:
receiving a reference picture list (RPL) for a current coding tree unit (CTU) of the current picture, the RPL identifying a plurality of reference pictures;
assigning indices to the plurality of reference pictures in the RPL of the current CTU;
receiving data to be decoded as a plurality of blocks of the current CTU; and
reconstructing the plurality of blocks of the CTU by using the assigned indices to select one or more reference pictures from the RPL to generate inter-predictions.
